(19) United States
(12) Patent Application Publication
(10) Pub. No.: US 2007/0256790 A1
(43) Pub. Date: Nov. 8, 2007

(54) Formation of a Tire Bead Assembly

(76) Inventor: Erik G. Nijhuis, Hengelo (NL)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/569,904

(22) PCT Filed: Jun. 3, 2005
(86) PCT No.: PCT/EP05/05967

§ 371 Date: Dec. 1, 2006

(30) Foreign Application Priority Data
Jun. 4, 2004 (GB) 0412573.8

(51) Int. Cl. B29D 30/48

(52) U.S. Cl. 156/422

(57) ABSTRACT

A method of forming a tire bead assembly comprises providing a length of an apex filler of elastomeric material (7), the apex filler having an annular base portion for positioning axially adjacent a bead core ring (16) on a support and an annular tapering portion for extending axially away from the base portion and the bead core ring, gripping a leading end of said length of apex filler so as to retain said end on a cylindrical former (30), gripping a trailing end of said length of apex filler using gripping means (6), rotating said cylindrical former (30) so that said length of apex filler (7) is wound thereon in a single turn, whilst moving said gripping means and said gripped trailing end towards said cylindrical former (30), joining said leading and trailing ends together, and flipping the apex filler (7) so that the base portion radially surrounds the bead core ring (16) and adheres to the latter and the tapering portion extends generally radially outwardly.

This invention relates to a method and apparatus for forming a tire bead assembly of a bead ring and surrounding elastomeric filler material.

A vehicle tire has two laterally spaced apart bead portions which define the innermost diameter of the tire. Each bead portion normally comprises an assembly of an inner metallic tire bead core formed from a plurality of turns of bead wire and an apex filler of elastomeric material surrounding the bead core. The tire bead assemblies provide a smooth transition between the beads and the adjacent side walls of the tire.

A known method of manufacturing a tire bead assembly comprises supporting a preformed bead ring on a support and positioning an annular elastomeric apex filler on a drum so as to be axially adjacent the bead ring. The apex filler is preferably partially uncured and still tacky and comprises an annular base portion adjacent the bead ring and an annular tapering portion supported on an inflatable bladder of the drum and extending away from the base portion and bead ring in the axial direction. On inflation of the bladder the apex filler is flipped over so that the base portion is positioned to surround the bead ring with the tapering portion extending radially outwardly. The still tacky elastomeric apex filler is held in its flipped over position by the bladder until the elastomeric material cures with the apex filler adhered to the bead ring.

As an alternative to an inflatable bladder, EP-A-0590906 discloses rigid flipping means for flipping over the apex filler.

The present invention seeks to provide a new method and apparatus of forming a tire bead assembly.

According to one aspect of the present invention there is provided a method of forming a tire bead assembly comprising providing a length of an apex filler of elastomeric material, the apex filler having an annular base portion for positioning axially adjacent a bead core ring on a support and an annular tapering portion for extending axially away from the base portion and the bead core ring, gripping a leading end of said length of apex filler so as to retain said end on a cylindrical former, gripping a trailing end of said length of apex filler using gripping means, rotating said cylindrical former so that said length of apex filler is wound thereon in a single turn, whilst moving said gripping means and said gripped trailing end towards said cylindrical former, joining said leading and trailing ends together, and flipping the apex filler so that the base portion radially surrounds the bead core ring and adheres to the latter and the tapering portion extends generally radially outwardly.

The apex filler is conveniently fed in a strip to the cylindrical former and is cut to its desired length upstream of the cylindrical former.

The method may comprise cutting said length of apex filler at an angle other than 90°, e.g. approximately 45°, to its longitudinal direction. The ends of the length of apex filler may be joined by pressing thereon.

The method may comprise gripping said leading end of said length of apex filler using said gripping means and bringing the thus-gripped leading end to the cylindrical former. In an alternative embodiment, an additional gripping means grips a leading end of a subsequent length of apex filler, and moves towards the cylindrical former together with the trailing end gripping means. This speeds up production, since the leading end of the subsequent length of apex filler is adjacent the cylindrical former and is ready to be gripped thereon as soon as the first length of apex filler has been flipped off the former.

The apex filler material may be flipped over using rigid flipping means. The flipped over apex filler may be pressed radially inwardly against the bead core ring by pressing means until the annular base portion is adhered to the bead core ring.

According to another aspect of the invention, there is provided a method of forming a tire bead assembly comprising providing a cut length of an apex filler of elastomeric material in an annular configuration on a drum, the apex filler having an annular base portion for positioning axially adjacent a bead core ring on a support and an annular tapering portion for extending axially away from the base portion and the bead core ring, so that the cut ends are aligned and abut one another, and flipping the apex filler using a plurality of circumferentially spaced rigid flipping means, so that the base portion radially surrounds the bead core ring and adheres to the latter and the tapering portion extends generally radially outwardly, the rigid flipping means being actuated to flip the apex filler by means of an actuator, the positions of the rigid flipping means being radially adjustable so as to accommodate tire beads of different sizes.

Conveniently, the actuator is moved by an axially-movable plate comprising camming means for radially adjusting the positions of the rigid flipping means.

According to a final method aspect of the invention there is provided a method of forming a tire bead assembly, comprising winding a bead core ring on a former arranged coaxially with a drum at a bead core winding station; transferring the bead core ring to the drum, moving the drum from said bead wire winding station to least one further station, and adhering a length of apex filler or elastomeric material to said bead core ring so that a base portion thereof surrounds the bead core ring and adheres to the latter and a tapering portion thereof extends generally radially outwardly.

The bead core ring may be wound either as a single wire bead or as a so-called “weftless” bead in which a number of wires are wound in parallel.

According to another aspect of the present invention there is provided apparatus for forming a tire bead assembly comprising a cylindrical former for supporting a cut length of an apex filler of elastomeric material, a drum positionable adjacent said former for supporting a bead core ring, a first gripping means arranged on a cylindrical former for gripping a leading end of said length of apex filler so as to retain said end on said cylindrical former whilst said length of apex filler is wound in a single turn thereon, a second gripping means for gripping a trailing end of said length of apex filler, said second gripping means being movable towards and away from said cylindrical former, means for joining aligned cut ends of the length of apex filler when the latter is wound in a single turn on the cylindrical former, and rigid flipping means for flipping the apex filler when wound on the former so that a base portion thereof surrounds the bead wire ring and adheres to the latter and a tapering portion thereof extends generally radially outwardly.

Cutting means may be provided for cutting the apex filler to a desired length at an angle other than 90°, e.g. approximately 45°, to its longitudinal direction.

A third gripping means may be provided for gripping a leading end of a subsequent length of apex filler and moving said leading end towards the cylindrical former.

The rigid flipping means may in particular comprise a plurality of circumferentially spaced apart fingers movable, e.g. pivotable, between inner and outer positions.

Conveniently the drum is movable axially towards and away from the former. Preferably the drum is movable axially relative to the rigid flipping means.

According to yet another aspect of the invention there is provided apparatus for forming a tire bead assembly, comprising a cylindrical former for supporting a length of an apex filler of elastomeric material, a drum positionable adjacent said former for supporting a bead core ring, rigid flipping means for flipping the apex filler when wound on the cylindrical former in a single turn so that a base portion thereof radially surrounds the bead core ring and adheres to the latter and a tapering portion thereof extends generally radially outwardly, the rigid flipping means being actuated to flip the apex filler by means of an actuator, and adjusting means for moving said flipping means radially inwardly and outwardly so as to accommodate tire beads of different sizes.

The adjusting means may comprise a turnable plate having camming means, e.g. a spiral slot, and cam followers, e.g. projections received in the spiral slot, on the flipping means, turning of the plate relative to the flipping means causing the latter to move together radially inwardly or outwardly. Suitably the plate is also movable axially to actuate said actuator.

In an embodiment of the invention, the flipping means comprise angularly spaced fingers. The fingers may be arranged to expand circumferentially outwardly as they move radially outwardly. Such an arrangement avoids gaps in the support for the apex filler.

According to a final apparatus aspect of the invention there is provided apparatus for forming a tire bead assembly, the apparatus comprising a drum for supporting a bead core ring, the drum being movable between a bead wire winding station and at least one further station comprising means for adhering a length of apex filler or elastomeric material to said bead core ring so that a base portion thereof radially surrounds the bead core ring and adheres to the latter and a tapering portion thereof extends generally radially outwardly.

The at least one further station may comprise an apexing station including a plurality of circumferentially spaced rigid flipping means for flipping a length of an apex filler of elastomeric material from a cylindrical former on to the bead core ring.

In addition, the apparatus may include a pressing station comprising pressing means for radially pressing the flipped over apex filler inwardly against the bead core ring until the annular base portion is adhered to the bead core ring.

Conveniently the pressing means comprise a plurality of circumferentially spaced apart pressing members movable between radially inner and outer positions.

The apparatus may further include a take-off station, to which the drum is moved for removal of the tire bead assembly therefrom.

The drum may be mounted on a turntable at a distance from an axis of rotation of the latter, the turntable being rotatably indexed to move from station to station.

An embodiment of the invention will now be described, by way of example only, with particular reference to the accompanying drawings, in which:

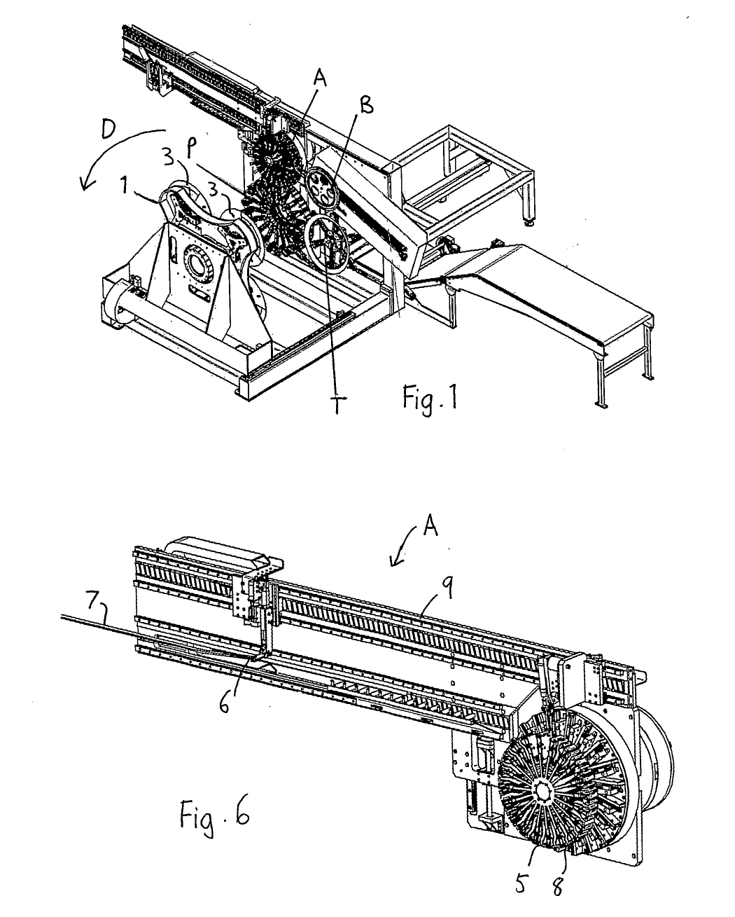

FIG. 1 is a perspective view of an apparatus according to the invention for forming a tire bead assembly;

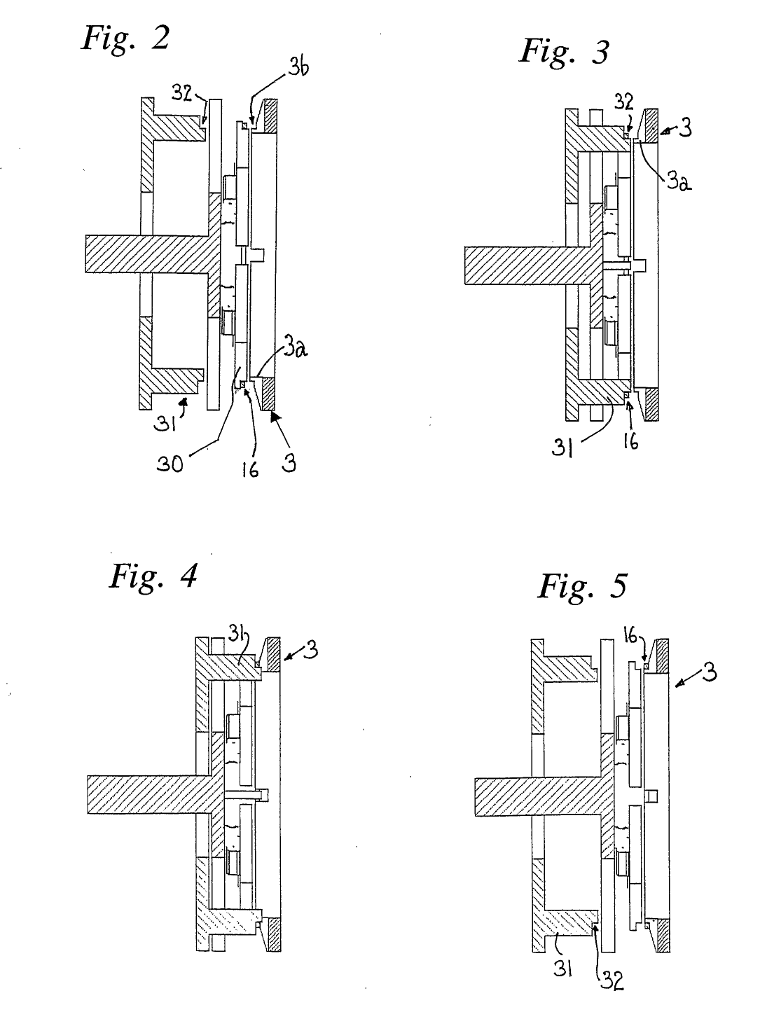

FIGS. 2 to 5 are schematic sectional views of the tire bead ring positioning station shown in FIG. 1;

FIG. 6 shows an apexing station of the apparatus of FIG. 1 in a first position;

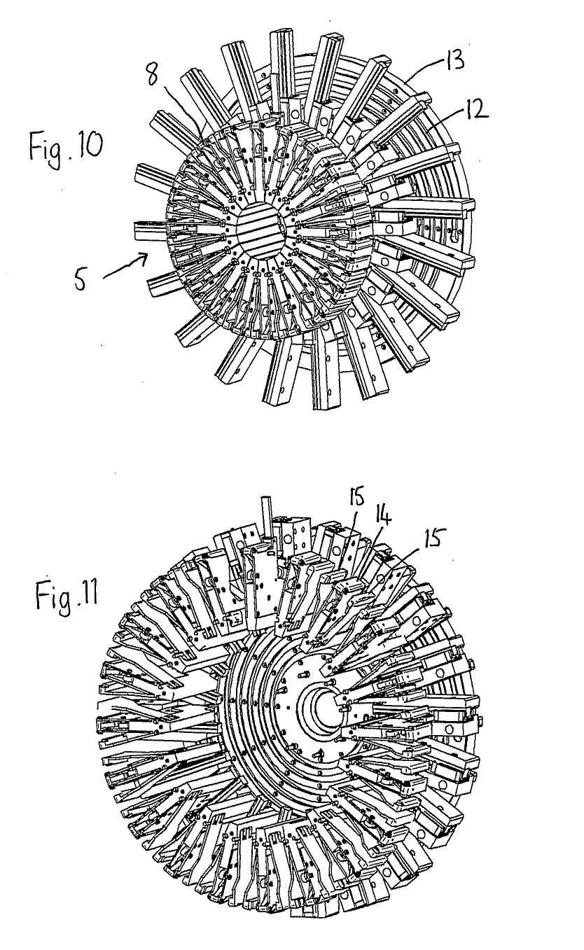

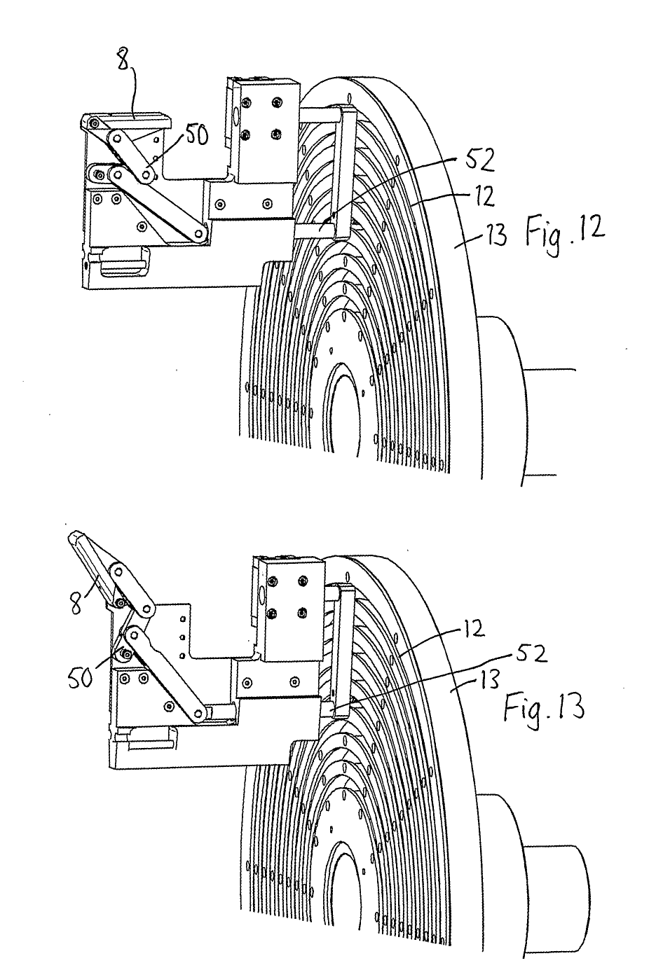

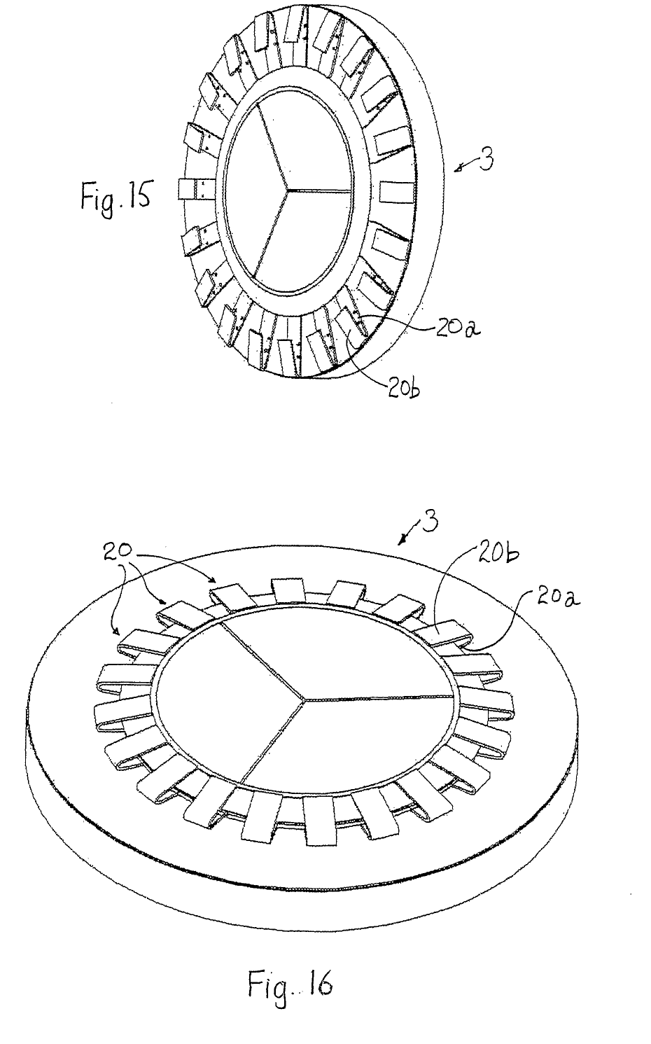

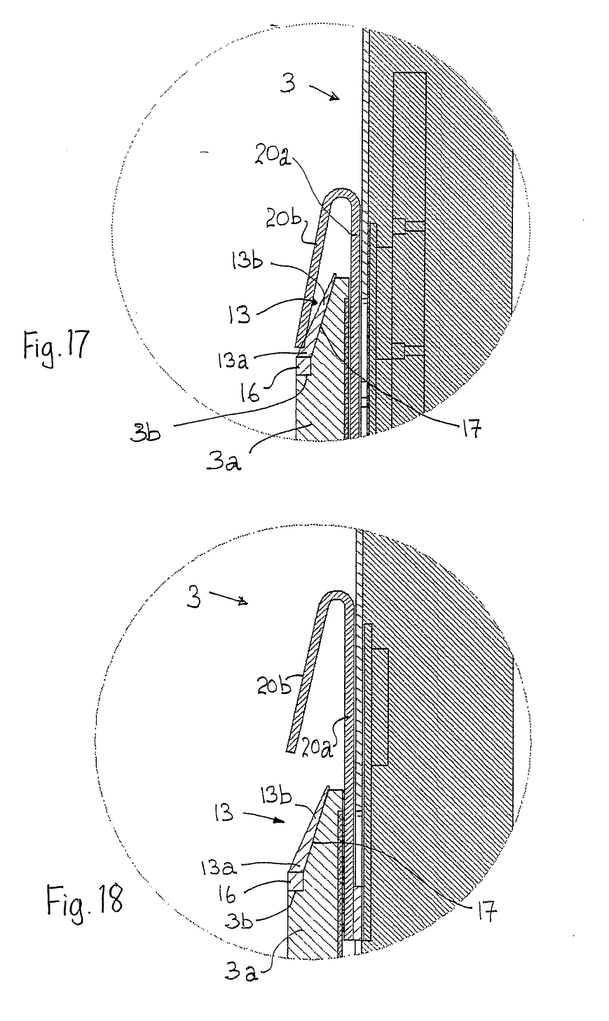

FIG. 7 is a fragmentary view showing a gripper clamping an end of the apex filler on to the former of the apexing station of FIG. 6;

FIG. 8 shows a cutting means of the apexing station;

FIG. 9 shows how the ends of the apex filler are joined;

FIGS. 10 and 11 show the cylindrical former configured for forming tire bead assemblies for small and large tires respectively;

FIG. 12 shows one of the flipping means in a non-flipped position;

FIG. 13 shows the flipping means of FIG. 12 in a flipped position;

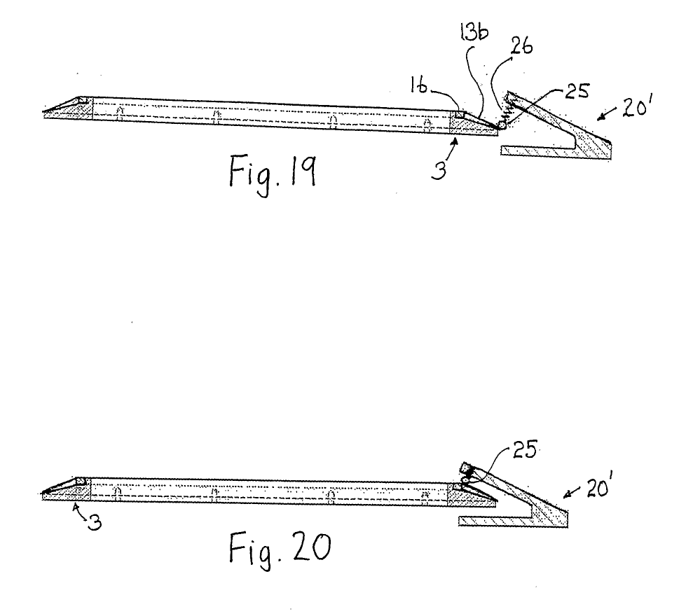

FIG. 14 shows the apexing station with the flipped-over apex filler;

FIGS. 15 and 16 are views of a support of a pressing station of the apparatus showing pressing means in radially outer and inner positions, respectively;

FIGS. 17 and 18 are schematic sectional views, on enlarged scales, showing one embodiment of the pressing means in radially outer and inner positions, respectively;

FIGS. 19 and 20 are schematic sectional views, on enlarged scales, showing another embodiment of the pressing means in radially outer and inner positions, respectively; and

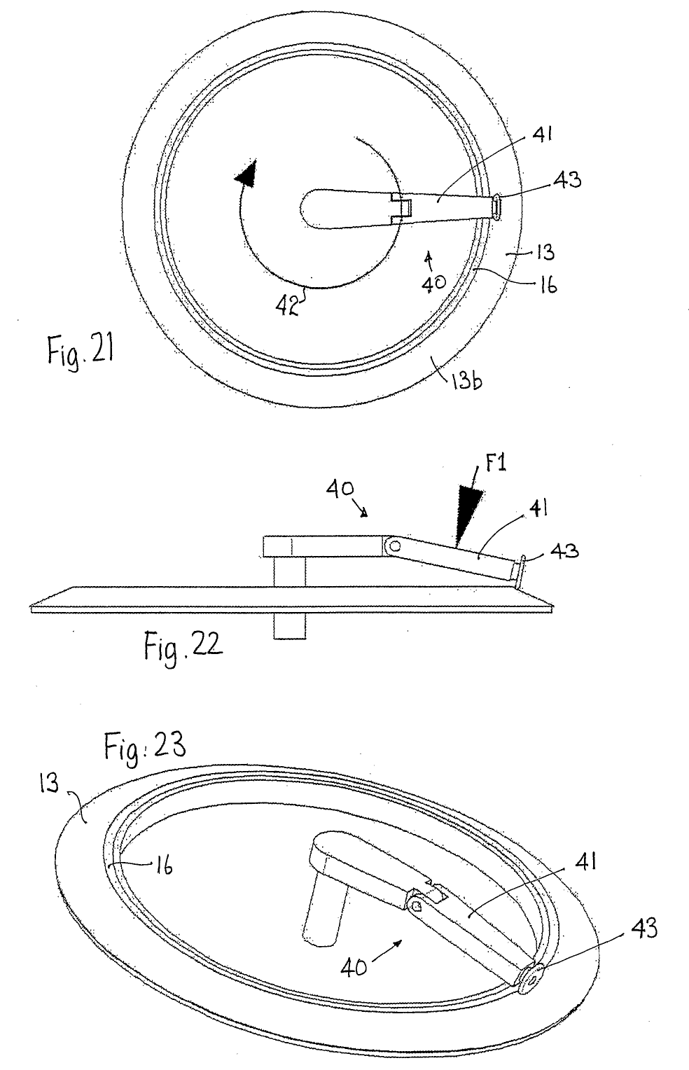

FIGS. 21 to 23 are different views of an alternative presser mechanism.

The Figures show an apparatus for forming a tire bead assembly of a bead wire core or ring 16 and surrounding elastomeric filler 13 (see FIGS. 13 and 14).

As shown in FIG. 1, the apparatus comprises an indexable carrier 1, such as a carousel, rotatable about a horizontal axis, on which a number, e.g. four, of drums 3 are mounted. The indexable carrier 1 is movable (i.e. turnable in the case of the carousel) to move each drum from one to another station. In the case of a carousel mounting equally spaced apart drums 3, there would typically, but not essentially, be a similar number of stations. Thus if the carousel has four drums 3 (as shown in FIG. 1), there would typically be four stations, namely a bead ring positioning station B, an apexing station A, a pressing station P and a take-off station T. Two of such stations could be combined into a single station or additional processing stations could be provided.

A convenient method of loading the bead wire ring 16 onto a cylindrical rim portion 3b of the drum 3, when the latter is at the bead ring positioning station B, is illustrated in FIGS. 2 to 5. FIG. 2 shows a bead wire ring 16 carried on a bead former 30 at the positioning station B. The ring may be formed at the station B in a known manner by winding either “single wire” or “weftless” tire bead core material onto the former 30. Alternatively, the ring 16 may have been pre-formed and subsequently positioned on item 30, which in this case does not function as a former, for example by means of a robotic arm. The bead former 30 is radially movable between inner and outer positions and in FIG. 2 is shown in its radially expanded position. A pusher mechanism 31 is also located at the positioning station and is axially movable between an axially inner position (FIG. 3) and an axially outer position (FIG. 2).

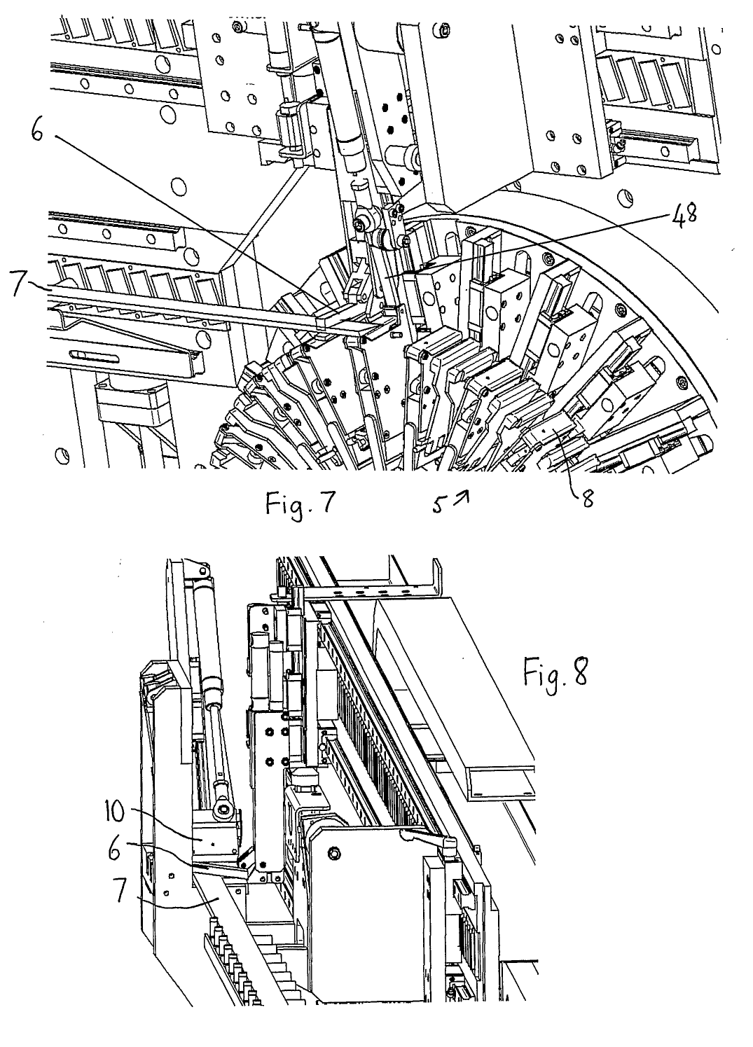

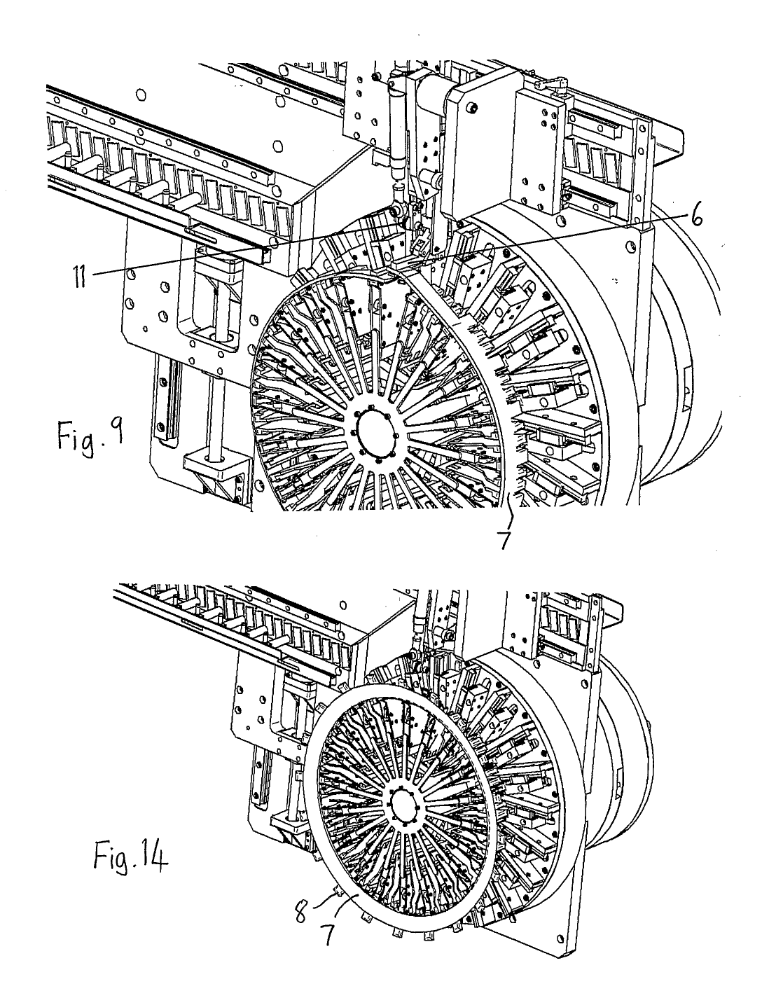

The pusher mechanism 31 has a carrier 32. In order to load the bead wire ring 16 onto the drum 3, the pusher mechanism is moved axially from its outer position and the bead former 30 is radially contracted to its inner position to enable the carrier 32 to collect the bead wire 16 previously supported on the former 30 (see FIG. 3). If not already in a radially collapsed condition, the drum is radially collapsed to allow the pusher mechanism 32 to move into its inner position (see FIG. 4) so that the bead wire ring 16, carried on the carrier 32, is moved onto the drum 3. The pusher mechanism is then moved back into its axially inner position and the drum 3 is radially expanded so that the bead wire ring 16 is supported on support member 3a as shown in FIG. 5.

As an alternative to the pusher mechanism shown in FIGS. 2 to 5, the drum 3 could be movable axially towards the bead former. Both the former and the drum are radially contracted, the drum is radially expanded to collect the bead wire ring 16 and is then moved away from the former.

In either embodiment, transfer of the bead wire ring 16 from the former to the drum 3 takes place with no gap therebetween, through which gap the bead wire ring might otherwise slip.

The indexable carrier 1 is then operated to move the drum 3 in direction D (FIG. 1) carrying the bead wire ring 16 into the apexing station A and then axially towards a cylindrical former 5 of the apexing station.

FIGS. 6 to 14 show the apexing station A, or parts of the apparatus positioned at the apexing station A.

As shown in FIG. 6, the cylindrical former 5 is defined by a plurality of rigid, circumferentially spaced apart fingers 8, and the apexing station further comprises a linear feed path 9. A gripper 6 is mounted on the feed path 9 and grips the cut end of a freshly-extruded elastomeric apex filler 7. The gripper 6 then moves, for example by means of a linear motor, to the position shown in FIG. 7. A former clamp 48, formed as part of one of the fingers 8, clamps the leading end of the apex filler on to the cylindrical former 5. The gripper 6 is then released and returns to the position of FIG. 6. The gripper is also shown at this position in FIG. 8. The gripper again clamps the apex filler 7 and a cutting means 10, comprising a knife, cuts the apex filler at an angle of 45° to the feed direction at a position spaced from the leading end thereof by a distance substantially equal to the circumference of the cylindrical former 5. The cylindrical former 5 is rotated through one revolution so as to wind the apex filler 7 thereon, as shown in FIG. 9. During this winding the gripper 6 carries the trailing end of the apex filler towards the cylindrical former, at a speed which is matched to the circumferential speed of the cylindrical former by electronic controls. This avoids flailing of the apex filler 7.

In an alternative embodiment, prior to cutting the apex filler 7, the latter is wound on to the cylindrical former 5 by rotating the latter through part of a revolution, for example through 340°. The apex filler 7 is then cut near to the cylindrical former and its trailing end is held by the gripper which moves as the former turns through the remainder of the revolution.

In still a further embodiment, there are two grippers, both movable along the linear feed path 9. The gripper nearest the cylindrical former grips the trailing end of the length of apex filler being wound on to the cylindrical former 5, as mentioned above. The other gripper grips the leading end of a subsequent length of apex filler and moves adjacent the trailing end gripper. Thus, the leading end of the subsequent length is ready near the cylindrical former as soon as the first length is unloaded therefrom, and the rate of production is increased.

The ends of the length of apex filler 7, both of which have been cut at 45°, now abut each other with the trailing end overlying the leading end. A wheel means 11 presses down on said trailing end and the two still tacky ends are thus adhered together without requiring an additional adhesive.

FIG. 10 shows the cylindrical former 5 configured for forming a tire bead assembly of relatively small diameter, e.g. 38 cm. The fingers 8 are mounted for radial movement and their positions are adjusted by adjusting means comprising projections received in a cam slot, e.g. a spiral slot 12 in a plate 13. When relative rotation takes place between the fingers and the plate 13, the cam follower projections move along the spiral slot 12, causing the fingers 8 to move radially inwardly or outwardly, depending on the direction of rotation.

FIG. 11 shows the fingers 8 moved radially outwardly to form a tire bead assembly of larger diameter, e.g. 61 cm. Each finger 8 comprises a central elongate member 14 and outer jaws 15. As the finger moves radially outwardly, the jaws 15 expand, helping to maintain the circular shape of the cylindrical former 5 and avoiding large gaps between the fingers 8.

FIG. 12 shows one of the fingers 8 connected via a linkage 50 to an actuator 52 having projections extending through the spiral slot 12. From the position shown in FIG. 12, the plate 13 is moved axially towards the finger 8 which pushes the actuator to the left as shown in the Figure. This operates the linkage 50 which moves the finger 8 to the position shown in FIG. 13. The apex filler material 7 is flipped over by the fingers 8 over into the position shown in FIGS. 14, 17 and 18 in which the annular base portion 13a radially surrounds the bead ring 16 supported on the support member 3a and the tapering portion 13b extends like a collar radially outwardly of the annular base portion 13a and is pressed against an inclined annular support surface 17 (see FIGS. 17 and 18) of the support member 3a.

The drum 3 is then moved back away from the cylindrical former 5 which is then ready to accept elastomeric filler material to create another annulus of filler material on the cylindrical former 5.

The indexable carrier 1 is then operated to move the drum 3 to the pressing station P.

Circumferentially spaced apart presser members 20 (see FIGS. 15 and 16) mounted for radial movement are moved from a radially outer position (FIGS. 15 and 18) to a radially inner position (FIGS. 16 and 17). Each presser member 20 has a pair of pressing surfaces 20a and 20b angled relative to one another. On movement of the presser members into their inner positions, the surfaces 20a slide against a rear surface of the support member 3a and the pressing surfaces 20b engage a tapered surface of the annular tapering portion 13b and press the entire annulus of elastomeric material 13 radially inwardly onto the bead core ring 16 carried on the support member 3a. As can be seen in FIG. 17, the surface 20b presses the annular base portion against the bead core ring 16 in the radially innermost position of each presser member. The still tacky elastomeric filler material is thus pressed radially inwards onto the bead wire core until it is adhered to the latter. During this radially inward movement of the presser members 20, the pressing surfaces 20b stretch the filler material around its circumference to relieve stress in the filler material. The presser members 20 are then moved radially outwards to their outer positions (see FIG. 18). In a modified design shown in FIGS. 19 and 20, presser members 20′ are provided with roller means, e.g. one or more rollers 25 resiliently mounted by spring means 26 at the free end of each presser member, to press against the annular tapering portion 13b during radial inward movement of the presser movements.

FIGS. 21 to 23 show an alternative pressing means in which the elastomeric annular tapering portion 13b is pressed against the bead ring 16 by a rotatable presser mechanism 40 which can be rotated in the direction shown by arrow 42 and which comprises an arm 41 and a presser wheel 43 which on rotation presses the tapering portion 13b against bead ring 16 by application of a force F1.

The carrier 1 is then indexed so that the drum 3 is moved into the take-off station T, where the tire bead assembly of the bead wire core and elastomeric filler material is removed from the support member 3a. If the drum 3 is movable axially, removal of the tire bead assembly can be essentially the reverse of the process of loading the bead core ring 16 at the bead ring positioning station B.

For maximum production rates the indexable carrier 1 (e.g. the carousel 1) could be provided with the same number of drums 3 as there are “stations” so that on each indexed movement of the carrier, each support means is moved from one to another station. Alternatively, however, a single support means could be provided on the carrier for movement sequentially from one to the next station.

Although a four-station apparatus has been described above it will be appreciated that apparatus 1 with a different number of stations could be provided. For example in a three-station apparatus, the presser mechanism 40 could be integrated into the apexing station A. In a two- or three-station apparatus, the indexable carrier could be moved between a first station, at which the bead wire ring is positioned on the support member 3a and, subsequently, at which the completed tire bead assembly is removed.

It is possible for the drum 3 not to be mounted on an indexable carrier. In this case the support means 3 would remain in the forming station whilst the bead wire core is positioned on the support member 3a and, subsequently, when the completed tire bead assembly is removed from the support member 3a.

All forms of the verb “to comprise” used in this specification have the meaning “to consist of or include”.

1. A method of forming a tire bead assembly comprising providing a length of an apex filler of elastomeric material, the apex filler having an annular base portion for positioning axially adjacent a bead core ring on a support and an annular tapering portion for extending axially away from the base portion and the bead core ring, gripping a leading end of said length of apex filler so as to retain said end on a cylindrical former, gripping a trailing end of said length of apex filler using gripping means, rotating said cylindrical former so that said length of apex filler is wound thereon in a single turn, whilst moving said gripping means and said gripped trailing end towards said cylindrical former, joining said leading and trailing ends together, and flipping the apex filler so that the base portion radially surrounds the bead core ring and adheres to the latter and the tapering portion extends generally radially outwardly.

2. A method according to claim 1, wherein the apex filler is fed in a strip to the cylindrical former and is cut to its desired length upstream of the cylindrical former.

3. A method according to claim 2, comprising cutting said length of apex filler at an angle other than 90 to its longitudinal direction.

4. A method according to claim 3, wherein said angle is approximately 45.

5. A method according to claim 1, wherein the ends of the length of apex filler are joined by pressing thereon

6. A method according to claim 1, comprising gripping said leading end of said length of apex filler using said gripping means and bringing the thus-gripped leading end to the cylindrical former.

7. A method according to claim 1, wherein an additional gripping means grips a leading end of a subsequent length of apex filler, and moves towards the cylindrical former together with the trailing end gripping means.

8. A method according to claim 1, wherein the apex filler material is flipped over using rigid flipping means.

9. A method according to claim 8, wherein the flipped over apex filler is pressed radially inwardly against the bead core ring by pressing means until the annular base portion is adhered to the bead core ring.

10. A method of forming a tire bead assembly, comprising providing a cut length of an apex filler of elastomeric material in an annular configuration on a drum, the apex filler having an annular base portion for positioning axially adjacent a bead core ring on a support and an annular tapering portion for extending axially away from the base portion and the bead core ring, so that the cut ends are aligned and abut one another, and flipping the apex filler using a plurality of circumferentially spaced rigid flipping means, so that the base portion radially surrounds the bead core ring and adheres to the latter and the tapering portion extends generally radially outwardly, the rigid flipping means being actuated to flip the apex filler by means of an actuator, the positions of the rigid flipping means being radially adjustable so as to accommodate tire beads of different sizes.

11. A method according to claim 10, wherein the actuator is moved by an axially-movable plate comprising camming means for radially adjusting the positions of the rigid flipping means.

12. A method of forming a tire bead assembly, comprising winding a bead core ring on a former arranged coaxially with a drum at a bead core winding station; transferring the bead core ring to the drum, moving the drum from said bead wire winding station to at least one further station, and adhering a length of apex filler or elastomeric material to said bead core ring so that a base portion thereof surrounds the bead core ring and adheres to the latter and a tapering portion thereof extends generally radially outwardly.

13. A method according to claim 12, wherein the bead core ring is wound as a single wire bead.

14. A method according to claim 12, wherein the bead core ring is wound as a weftless bead.

15. A method according to claim 12, wherein the step of transferring the bead core ring to the drum takes place with no gap between the former and the drum.

16. An apparatus for forming a tire bead assembly, comprising a cylindrical former for supporting a cut length of an apex filler of elastomeric material, a drum positionable adjacent said former for supporting a bead core ring, a first gripping means arranged on a cylindrical former for gripping a leading end of said length of apex filler so as to retain said end on said cylindrical former whilst said length of apex filler is wound in a single turn thereon, a second gripping means for gripping a trailing end of said length of apex filler, said second gripping means being movable towards and away from said cylindrical former, means for joining aligned cut ends of the length of apex filler when the latter is wound in a single turn on the cylindrical former, and rigid flipping means for flipping the apex filler when wound on the former so that a base portion thereof surrounds the bead wire ring and adheres to the latter and a tapering portion thereof extends generally radially outwardly.

17. An apparatus according to claim 16, comprising cutting means for cutting the apex filler to a desired length at an angle other than 90 to its longitudinal direction.

18. An apparatus according to claim 17, wherein the angle is approximately 45.

19. An apparatus according to claim 16, comprising a third gripping means for gripping a leading end of a subsequent length of apex filler and moving said leading end towards the cylindrical former.

20. An apparatus according to claim 16, comprising means for joining the cut ends of the length of apex filler by pressing thereon.

21. An apparatus according to claim 16, wherein the rigid flipping means comprise a plurality of circumferentially spaced apart fingers movable between inner and outer positions.

22. An apparatus according to claim 16, wherein the drum is movable axially towards and away from the former.

23. An apparatus for forming a tire bead assembly, comprising a cylindrical former for supporting a length of an apex filler of elastomeric material, a drum positionable adjacent said former for supporting a bead core ring, rigid flipping means for flipping the apex filler when wound on the cylindrical former in a single turn so that a base portion thereof radially surrounds the bead core ring and adheres to the latter and a tapering portion thereof extends generally radially outwardly, the rigid flipping means being for moving said flipping means radially inwardly and outwardly so as to accommodate tire beads of different sizes.

24. An apparatus according to claim 23, wherein the adjusting means comprises a turnable plate having camming means, and cam followers, on the flipping means, turning of the plate relative to the flipping means causing the latter to move together radially inwardly or outwardly.

25. An apparatus according to claim 24, wherein the camming means comprises a spiral slot and the cam followers comprise projections received in the spiral slot.

26. An apparatus according to claim 24, wherein the plate is also movable axially to actuate said actuator.

27. An apparatus according to claim 23, wherein the flipping means comprise angularly spaced fingers.

28. An apparatus according to claim 27, wherein the fingers are arranged to expand circumferentially outwardly as they move radially outwardly.

29. An apparatus for forming a tire bead assembly, the apparatus comprising a drum for supporting a bead core ring, the drum being movable between a bead wire winding station and at least one further station comprising means for adhering a length of apex filler or elastomeric material to said bead core ring so that a base portion thereof radially surrounds the bead core ring and adheres to the latter and a tapering portion thereof extends generally radially outwardly.

30. An apparatus according to claim 29, wherein the at least one further station comprises an apexing station including a plurality of circumferentially spaced rigid flipping means for flipping a length of an apex filler of elastomeric material from a cylindrical former on to the bead core ring.

31. An apparatus according to claim 29, wherein the at least one further station comprises a pressing station comprising pressing means for radially pressing the flipped over apex filler inwardly against the bead core ring until the annular base portion is adhered to the bead core ring.

32. An apparatus according to claim 31, wherein the pressing means comprises a plurality of circumferentially spaced apart pressing members movable between radially inner and outer positions.

33. An apparatus according to claim 31, wherein the pressing means comprises a pressing member movable circumferentially around the apex filler to apply a pressing force thereto.

34. An apparatus according to claim 33, wherein the pressing member comprises an arm rotatable about the center of a former on which the tire bead assembly is mounted.

35. An apparatus according to claim 34, wherein a pressing wheel is mounted on said arm for applying the pressing force to the apex filler.

36. An apparatus according to claim 29, wherein the at least one further station comprises a take-off station, to which the drum is movable for removal of the tire bead assembly therefrom.

37. An apparatus according to claim 29, wherein the drum is mounted on a turntable at a distance from an axis of rotation of the latter, the turntable being rotatably indexed to move from station to station.
